(19) United States
(12) Patent Application Publication
(10) Pub. No.: US 2019/0007809 A1
(43) Pub. Date: Jan. 3, 2019

(54) Calibration of the Position of Mobile Objects in Buildings

(71) Applicant: Siemens Schweiz AG, Zürich (CH)

(72) Inventors: Christian Frey, Unterägeri (CH); Oliver Zechlin, Zug (CH); Christiane Mann, Alpharetta, GA (US)

(73) Assignee: Siemens Schweiz AG, Zürich (CH)

(21) Appl. No.: 16/067,989

(22) PCT Filed: Nov. 24, 2016
(86) PCT No.: PCT/EP2016/078692

§ 371 Date: Jul. 3, 2018

(30) Foreign Application Priority Data
Jan. 4, 2016 (DE) 10 2016 200 010.1

(51) Int. Cl. H04W 4/33; G01S 1/68; G01S 1/04; G01S 1/02

(52) U.S. Cl. CPC H04W 4/33; G01S 1/68; H04W 4/024; G01S 1/026; G01S 1/042

(57) ABSTRACT

The present disclosure relates to building management. Various embodiments may include methods for determining a current position of mobile objects in buildings including: transmitting a referenced item of position information to a mobile object; transmitting a building plan to the mobile object for display thereon; and providing a calibration calculation for determining the current position of the mobile object on the plans displayed on the mobile object based on the position information. The position information is unambiguously associated with the transmitting device and thus corresponds to a current location of the mobile object in the building. Transmission of the position information or of the reference thereto takes place within a directional radio emitting region.

### CROSS-REFERENCE TO RELATED APPLICATIONS

This application is a U.S. National Stage Application of International Application No. PCT/EP2016/078692 filed Nov. 24, 2016, which designates the United States of America, and claims priority to DE Application No. 10 2016 200 010.1 filed Jan. 4, 2016, the contents of which are hereby incorporated by reference in their entirety.

### TECHNICAL FIELD

The present disclosure relates to building management. Various embodiments of the teachings herein may include methods and arrangements for the calibration of the position of mobile objects in buildings.

### SUMMARY

The possibility for position determination of persons or mobile objects (e.g. smartphones, tablet computers) within buildings or covered (indoor) areas is becoming increasingly important. One reason is that in large buildings, people can quickly become disoriented. A further reason is numerous new applications in the indoor domain which make position location necessary. There are therefore numerous aids within buildings which support the people in making their way to difficult-to-find destinations. In particular, large building complexes such as retail centers, airports, hospitals, museums, and exhibition centers should offer an overview and/or orientation with direction signs, overview maps, and/or signposts. In particular, when a person enters the building for the first time, it is often very difficult and complex to orient and find their goal through the plurality of angled walkways, hallways, rooms, and levels. Global, satellite-supported positioning systems (GPS) fail to operate within covered areas due to a lack of availability of the satellite signals. This is because within rooms, the accuracy and reception strength of satellite-supported positioning systems rapidly diminish, even losing connection altogether.

For this reason, in the last few years, numerous new technologies and methods for realizing local positioning systems have been tested. Different sensors and methods for a robust position determination with the greatest possible accuracy are available. In particular, active systems are used which employ electromagnetic waves or sound waves as information carriers and carry out localization therewith.

Pseudolit GPS (transmission of simulated satellite signals by terrestrial transmitters) offers a very accurate method for location determination under laboratory conditions. However, the investment costs for the setting-up of a Pseudolit GPS system are very high, by reason of which there are currently hardly any buildings in which such a system is in use. Added to this is the fact that the Pseudolit stations would have to be installed purely for the purpose of position determination and offer no further added value. Errors occurring would have to be recognized as such and eliminated with corresponding correction calculations.

### SUMMARY

The teachings of the present disclosure may provide economical methods and arrangements for calibrating the position of mobile objects in buildings and/or of the sensor technology of mobile objects. For example, various embodiments may include a method for the calibration of the position of mobile objects (MO1, MO2) in buildings (GB1, GB2). The methods may include the following: transmitting a referenced item of position information (PS1-PS8) or a reference thereto by means of a radio-based transmitting device (SV1-SV12) located in the building, wherein the position information is unambiguously associated with the transmitting device (SV1-SV12) and thus communicates the current location to the mobile object (MO1, MO2) in the building (GB1, GB2); receiving the position information (PS1-PS8) by the mobile object (MO1, MO2); and calibrating the current position on the plans (GP) displayed on the mobile object for position determination of the mobile object (MO1, MO2), on the basis of the received position information (PS1-PS8), characterized in that the transmission of the position information (PS1-PS8) or of the reference thereto takes place within a bundled, in particular directional, radio emitting region (FS1-FS8).

As another example, some embodiments may include: transmitting an item of position information (PS1-PS8) or a reference thereto by means of a radio-based transmitting device (SV1-SV12) located in the building, wherein the position information is unambiguously associated with the transmitting device (SV1-SV12) and thus communicates the current location to the mobile object (MO1, MO2) in the building (GB1, GB2); receiving the position information (PS1-PS8) by the mobile object (MO1, MO2); and calibrating sensor technology integrated into the mobile object for position determination of the mobile object (MO1, MO2), on the basis of the received position information (PS1-PS8), characterized in that the transmission of the position information (PS1-PS8) or of the reference thereto takes place within a bundled, in particular directional, radio emitting region (FS1-FS8).

In some embodiments, the bundled radio emitting region (FS1-FS8) is radiated at an angle of not more than 10 degrees about its central axis (MA) from the transmitting device (SV1-SV12).

In some embodiments, the bundled radio emitting region (FS1-FS8) is radiated in the form of a substantially straight circular cone (KK) by the transmitting device (SV1-SV12), wherein the central axis (MA) of the circular cone (KK) is directed substantially perpendicularly to a receiving plane (EE), wherein the aperture angle α forming the circular cone (KK) is not more than 19 degrees.

In some embodiments, the bundled radio emitting region (FS1-FS8) is radiated in the form of a substantially straight circular cone by the transmitting device (SV1-SV12) in the direction of a receiving plane (EE), wherein the central axis (MA) of the circular cone (KK) is directed substantially perpendicularly toward the receiving plane (EE), wherein the aperture angle α forming the circular cone (KK) is selected so that the clearance width (B) formed by the circular cone (KK) on the receiving plane (EE) is not more than 1 meter.

In some embodiments, the cone is emitted downwardly in the vertical direction from above or vice versa, or in a horizontal direction, for example, between two walls of the building.

In some embodiments, the position information (PS1-PS8) and/or the reference thereto can be received by the mobile object in a radius (RA) of ±100 cm, in particular ±50 cm about the central axis (MA) of the radio beam (FS1-FS8) on impacting upon the mobile object (MO1, MO2).

In some embodiments, the bundled radio beam is fed directed by the transmitting device (SV1-SV12) to the mobile object (MO1, MO2).

In some embodiments, the method is used for the navigation of mobile objects (MO1, MO2) in a building (GB1, GB2), wherein by means of the received position information (PS1-PS8) of the transmitting device (SV1-SV12), a first location is specified as the reference point of the mobile object in the building (GB1, GB2); wherein starting from the first location of the mobile object (MO1, MO2), making use of the navigation sensor technology integrated into the mobile object (MO1, MO2), a current location of the mobile object (MO1, MO2) is continuously determined, wherein a further transmitting device (SV1-SV12) is mounted at a second location for transmitting a further item of position information (PS1-PS8) which is associated with the further transmitting device (SV1-SV12), and wherein the currently determined location is calibrated to the second location of the transmitting device when the further item of position information (PS1-PS8) is received by the mobile object (MO1, MO2).

In some embodiments, on the basis of the calibrated position or the calibrated sensor technology, digital maps or building plans (GP) of the building (GB1, GB2) stored in the mobile object (MO1, MO2) are recalibrated for position display.

As another example, some embodiments may include an arrangement for calibrating the position of mobile objects (MO1, MO2) in buildings (GB1, GB2). The arrangement may include: a transmitting device (SV1-SV12) located in the building (GB1, GB2) for transmitting an item of position information (PS1-PS8) and/or a reference thereto, wherein the position information (PS1-PS8) is unambiguously associated with the transmitting device (SV1-SV12) and thus communicates the current location to the mobile object in the building (GB1, GB2); a mobile object (MO1, MO2) with integrated sensor technology for position determination of the mobile object (MO1, MO2) in a building (GB1, GB2) and a receiving device for receiving the position information (PS1-PS8) and/or the reference thereto; wherein the mobile object (MO1, MO2) is configured, on the basis of the received position information (PS1-PS8), to carry out a calibration of the position shown on the mobile object for position determination, characterized in that the transmitting device (SV1-SV12) is configured to transmit a bundled, in particular directional, radio beam (FS1-FS8) with the position information (PS1-PS8) and/or the reference thereto.

Some embodiments may include: a transmitting device (SV1-SV12) located in the building (GB1, GB2) for transmitting an item of position information (PS1-PS8) and/or a reference thereto, wherein the position information (PS1-PS8) is unambiguously associated with the transmitting device (SV1-SV12) and thus communicates the current location to the mobile object in the building (GB1, GB2); a mobile object (MO1, MO2) with integrated sensor technology for position determination of the mobile object (MO1, MO2) in a building (GB1, GB2) and a receiving device for receiving the position information (PS1-PS8) and/or the reference thereto; wherein the mobile object (MO1, MO2) is configured, on the basis of the received position information (PS1-PS8), to carry out a calibration of the sensor technology integrated into the mobile object (MO1, MO2) for position determination, characterized in that the transmitting device (SV1-SV12) is configured to transmit a bundled, in particular directional, radio beam (FS1-FS8) with the position information (PS1-PS8) and/or the reference thereto.

In some embodiments, the transmitting device (SV1-SV12) is configured to transmit the bundled radio beam (FS1-FS8) from the transmitting device (SV1-SV12) at an angle of not more than 10 degrees about the central axis (MA) of the radio beam.

In some embodiments, the transmitting device (SV1-SV12) is configured such that the bundled radio emitting region (FS1-FS8) is radiated in the form of a substantially straight circular cone (KK) by the transmitting device (SV1-SV12) in the direction of a receiving plane (EE), wherein the central axis (MA) of the circular cone (KK) is directed substantially perpendicularly toward the receiving plane (EE), wherein the aperture angle α forming the circular cone (KK) is selected so that the clearance width (B) formed by the circular cone (KK) on the receiving plane (EE) is not more than 1 meter.

In some embodiments, the mobile object is configured, on the basis of the received position information (PS1-PS8), to undertake a referencing of the digital maps or building plans (GP) stored in the mobile object for calibration of the position display on the mobile object (MO1, MO2) or of the sensor technology integrated into the mobile object (MO1, MO2).

In some embodiments, the transmitting device (SV1-SV12) is configured to feed the bundled radio beam (FS1-FS8) directed to the mobile object (MO1, MO2).

In some embodiments, the transmitting device (SV1-SV12) is mounted in the building (GB1, GB1) at locations where, due to the construction of the building (GB1, GB2) or due to technical equipment in the building (GB1, GB2), persons (P1, P2) situated in the building (GB1, GB1), are detected with a high probability by the radio beam (FS1-FS8) of the transmitting device (SV1-SV12).

In some embodiments, the transmitting device (SV1-SV12) is mounted, in particular, at one of the following locations in the building (GB1, GB2): entries, exits, throughways, access to lifts, start and end of escalators, access to toilets.

In some embodiments, the transmitting device (SV1-SV12) is integrated into an infrastructure element of the building (GB1, GB2), in particular, a fire alarm or a lighting element.

### BRIEF DESCRIPTION OF THE DRAWINGS

Various embodiments of the teachings of the present disclosure will now be described in greater detail by reference to the accompanying drawings. In the drawings:

FIG. 1 shows a first exemplary arrangement for the calibration of the position of mobile objects in a building, according to the teachings herein;

FIG. 2 shows a second exemplary arrangement for the calibration of the position of mobile objects in a building, according to the teachings herein;

FIG. 3 shows an exemplary flow diagram for a method for calibrating the position of mobile objects in a building, according to the teachings herein; and

FIG. 4 shows an exemplary building plan with an exemplary position display, according to the teachings herein.

### DETAILED DESCRIPTION

Various embodiments may include a method comprising:
transmitting an item of position information or a reference thereto by means of a radio-based transmitting device located in the building, the position information being unambiguously associated with the transmitting device and thus communicating the current location to the mobile object in the building;
receiving the position information by the mobile object; and
calibrating the current position, i.e. the current location of the mobile object on the plans displayed on the mobile object for position determination of the mobile object, on the basis of the received position information, wherein the transmission of the position information or of the reference thereto takes place within a bundled, in particular directional, radio emitting region.

In some embodiments, the position information is an item of position information referenced to the respective location of the respective transmitting device. In some embodiments, the radio emitting region is formed by a directed radio beam transmitted by the transmitting device. The radio beam is may be directed to a receiving plane or a target point.

In some embodiments, the mobile objects comprise portable electronic devices such as smartphones, smart watches, smart glasses, and/or tablet computers which have a sensor technology, for example, accelerometer, magnetometer, gyroscope, and/or barometer. This sensor technology can be used for position determination and/or navigation. This sensor technology has the disadvantage that its measuring results easily go “off course”. By means of the automatic calibration of the position, the measurement error is eliminated. This takes place without the interaction of the user of these mobile devices. A transmitting device with its respectively unambiguously associated position information acts like a reference beacon for the calibration or re-calibration. If the mobile object is situated in a radio emitting region of a transmitting device, the calibration and/or re-calibration of the mobile objects takes place on the basis of the position information received in the respective radio emitting region by the mobile object. The transmitting device can be a WLAN, Bluetooth, or Zigbee transmitter or a combination of transmitters (beacons).

In some embodiments, the transmitting device corresponds to a reference beacon which like a beacon light transmits its position information and this is then used for the calibration or re-calibration of the position of a mobile object (mobile device).

Some embodiments may include methods for the calibration of the position of mobile objects in buildings (GB1, GB2) comprising:
transmitting an item of position information or a reference thereto by means of a radio-based transmitting device located in the building, the position information being unambiguously associated with the transmitting device and thus communicating the current location to the mobile object in the building;
receiving the position information by the mobile object; and
calibrating sensor technology integrated into the mobile object for the position determination of the mobile object, on the basis of the received position information, wherein the transmission of the position information or of the reference thereto takes place within a bundled, in particular directional, radio emitting region.

In some embodiments, the mobile objects comprise portable electronic devices such as smartphones, smart watches, smart glasses, and/or tablet computers which have a sensor technology, for example, accelerometer, magnetometer, gyroscope, barometer. This sensor technology can be used for position determination and/or navigation. This sensor technology has the disadvantage that its measuring results easily go “off course”. By means of the automatic calibration of this sensor technology, the measurement error is eliminated. This takes place without the interaction of the user of these mobile devices. A transmitting device with its respectively unambiguously associated position information acts like a reference beacon for the calibration or re-calibration. If the mobile object is situated in a radio emitting region of a transmitting device, the calibration or re-calibration of the mobile objects takes place on the basis of the position information respectively received in the respective radio emitting region by the mobile object.

In some embodiments, the bundled radio emitting region is radiated in an angle of not more than 10 degrees about its central axis by the transmitting device. (A radiating angle of 19 degrees results therein that the beam cone has a diameter of 1 m at 3 m distance). In some embodiments, the central axis corresponds to the main radiating direction in which the transmitting device directionally radiates the radio emitting region.

In some embodiments, the bundled (directed) radio emitting region is radiated in the form of a substantially straight circular cone by the transmitting device, wherein the central axis of the circular cone is directed substantially perpendicularly to a receiving plane, wherein the aperture angle a forming the circular cone is not more than 19 degrees. With a radiating angle of 19 degrees, at 3 m distance, a light or radio cone has a diameter of 1 m on a receiving plane arranged opposite the transmitting device. A mobile object located in the circular cone thereby receives an item of position information for a calibration of the position of the mobile object with sufficient accuracy.

In some embodiments, the bundled (directed) radio emitting region is radiated by the transmitting device in the form of a substantially straight circular cone in the direction of a receiving plane, wherein the central axis of the circular cone is directed substantially perpendicularly to the receiving plane, wherein the aperture angle α forming the circular cone is selected so that the clearance width formed on the receiving plane is not more than 1 m. With a radiating angle of 19 degrees, at 3 m distance, a light or radio cone has a diameter of 1 m on a receiving plane arranged opposite the transmitting device. A mobile object situated in the circular cone thereby receives an item of position information for a calibration of the position of the mobile object with sufficient accuracy.

In some embodiments, the cone is emitted downwardly in the vertical direction from above or vice versa, or in a horizontal direction, for example, between two walls of the building. By this means, a reliable reception of the position information on the mobile device (mobile object) is ensured.

In some embodiments, the position information and/or the reference thereto by the mobile object can be received in a radius of ±100 cm, in particular ±50 cm about the central axis of the radio beam on arrival at the mobile object. In some embodiments, the position information and/or the reference thereto by the mobile object can only be received in a radius of ±100 cm, in particular ±50 cm about the central axis of the radio beam on arrival at the mobile object. In some embodiments, the radio beam originating from the transmitting device is oriented vertically downwardly. Then, possible errors relating to the position information received at the mobile device are very small. In some embodiments, the radiating angle for the radio emitting region (substantially a circular cone) is selected so that the mobile object (e.g. smartphone) crosses this radio emitting region in a radius of ±100 cm, in particular ±50 cm. A mobile object situated in the circular cone thereby receives an item of position information for a calibration of the position of the mobile object with sufficient accuracy.

In some embodiments, the bundled radio beam is fed by the transmitting device directed toward the mobile object. The targeted feeding can take place by means of dynamic antenna adjustment, i.e. by adjusting the radio beam toward the mobile object which is moving past (e.g. smartphone, smart watch, smart glasses, tablet, etc.). The target device receives the transmitted position information or an ID of the respective transmitting device from which the position of the respective transmitting device can be determined. This can take place in the mobile object offline in an app, or online by means of a connection of the mobile object to a server (e.g. a building automation system).

In some embodiments, a method includes based on the received position information of the transmitting device, a first location is specified as the reference point (e.g. as the starting point) of the mobile object in the building; wherein starting from the first location of the mobile object, making use of the navigation technology (e.g. gyroscope, acceleration sensors, barometer, WLAN) integrated into the mobile object, a current location of the mobile object is continuously determined, wherein a further transmitting device is mounted at a second location for transmitting a further item of position information which is associated with the further transmitting device; and wherein the currently determined location is calibrated to the second location of the transmitting device (reference point) when the further item of position information is received by the mobile object. By this means, a correspondingly configured mobile object can be used not only for position determination, but also for navigation in a building.

In some embodiments, on the basis of the calibrated position or the calibrated sensor technology, digital maps or building plans of the building stored in the mobile object are recalibrated for position display. The building plans can be provided, for example, by means of a building automation system. In some embodiments, the building plans are part of a BIM model (building information model) or system. The building plans may be loaded onto the mobile object (e.g. smartphone, tablet computer) by means of a download from the building automation system, advantageously by means of a web server.

In some embodiments, there is an arrangement for the calibration of the position of mobile objects in buildings comprising: a transmitting device located in the building for transmitting an item of position information and/or a reference thereto, wherein the position information is unambiguously associated with the transmitting device and thus communicates the current location to the mobile object in the building; a mobile object with integrated sensor technology for position determination of the mobile object in a building and a receiving device for receiving the position information and/or the reference thereto; the mobile object being configured, on the basis of the received position information, to carry out a calibration of the position shown on the mobile object for position determination.

In some embodiments, the transmitting device is configured to transmit a bundled, in particular directional, radio beam with the position information and/or the reference thereto. The arrangement can be realized with components that are already commonly present in a building. The bundled, in particular, directional radio beam emitted by the transmitting device can emerge, for example, through a suitable screening cover or other building-related measures (e.g. mounting of the transmitter set back in a blind hole through the opening of which the radio beams emerge). The transmitting device (beacon) can be based, for example, on WLAN, Bluetooth or ZigBee.

In some embodiments, an arrangement comprises:
a transmitting device located in the building for transmitting an item of position information and/or a reference thereto, wherein the position information is unambiguously associated with the transmitting device and thus communicates the current location to the mobile object in the building;
a mobile object with integrated sensor technology for position determination of the mobile object in a building and a receiving device for receiving the position information and/or the reference thereto; the mobile object being configured, on the basis of the received position information, to carry out a calibration of the sensor technology integrated into the mobile object for position determination, the transmitting device being configured to emit a bundled, in particular directed, radio beam with the position information and/or the reference thereto. In some embodiments, the transmitting device is configured to transmit the bundled, advantageously directed, radio beam from the transmitting device in an angle of not more than 10 degrees about the central axis of the radio beam. In some embodiments, the central axis corresponds to the main radiating direction in which the transmitting device directionally radiates the radio emitting region. A mobile object located in the radio emitting region thereby receives an item of position information for a calibration of the position of the mobile object with sufficient accuracy.

In some embodiments, the transmitting device is configured such that the bundled, in particular directed, radio emitting region is radiated by the transmitting device in the form of a substantially straight circular cone in the direction of a receiving plane, the central axis of the circular cone being directed substantially perpendicularly to the receiving plane, wherein the aperture angle α forming the circular cone is selected so that the clearance width formed on the receiving plane is not more than 1 m. A mobile object situated in the circular cone thereby receives an item of position information for a calibration of the position of the mobile object with sufficient accuracy.

In some embodiments, the mobile object is configured, on the basis of the received position information, to undertake a referencing of the digital maps or building plans stored in the mobile object for calibration of the position display on the mobile object or of the sensor technology integrated into the mobile object. The maps or building plans, for example, from a building automation system can be provided for the mobile object (e.g. smartphone, smart watch, smart glasses, tablet computer), for example by means of a suitable download to the mobile object. With the relevant maps or building plans, the mobile object can be used as a navigation device, dedicated for the respective building.

In some embodiments, the transmitting device is configured to feed the bundled radio beam directed toward the mobile object. The targeted feeding can take place by means of dynamic antenna adjustment, i.e. by adjusting the radio beam to the mobile object which is moving past (e.g. smartphone, smart watch, smart glasses, tablet, etc.).

In some embodiments, the transmitting device is mounted in the building at locations where, due to the construction of the building or due to technical equipment in the building, mobile objects situated in the building, for example, in the hand of a person, are captured with a high probability by the radio beam of the transmitting device. By this means, the investments in the infrastructure for the installation of the inventive arrangement are very small, e.g. in the case of entrances with turnstiles.

In some embodiments, the transmitting device is mounted, in particular, at one of the following locations in the building: entries, exits, throughways, access to lifts, start and end of escalators, access to toilets. Such locations are visited or passed through with a high probability by persons who carry the mobile object with them. Optionally, mechanical barriers can also be installed in the building in order to guide persons into a radio emitting region (with a reference beacon).

In some embodiments, the transmitting device is integrated into an infrastructure element of the building, in particular, a fire alarm or a lighting element. In some embodiments, the infrastructure element belongs to the usual equipment of a building, for example, a danger alarms, access control, loudspeakers, lamps, camera. By this means, only small investment costs are incurred. Furthermore, the transmitting devices are installed hidden in the infrastructure elements.

Nowadays, technologies are available which are usable in principle for indoor positioning (determination of the position in buildings or building projects) or indoor navigation. Bluetooth is, for example, a technology supported by many smartphones. Originally, it was used to exchange data between personal digital assistants or mobile telephones. Now, ever more accessory devices for mobile telephones are appearing on the market, such as headsets which communicate with the device by means of Bluetooth. Bluetooth involves a short distance communication (<10 m), wherein Bluetooth devices transmit in the frequency range between 2.402 GHz and 2.480 GHz. As a result, it is however highly susceptible to interference from WLAN networks, wireless telephones, or microwave ovens.

A peculiarity of Bluetooth is the asymmetrical data transfer, which means that transmission and reception can occur simultaneously. A sufficiently accurate navigation by means of Bluetooth beacons can take place in that within a building sufficient sensors are installed which communicate their fixed location to the device, whereupon said device can calculate its location given sufficiently many received signals by means of triangulation. The average transmission range indoors is approximately ten meters depending on the manner and type of the implementation, which with whole-area coverage in a building, results in high investment costs.

Added to this is that it is not with every Bluetooth type that an inquiry regarding transmission strength is possible without having a fixed connection to the transmitter. Furthermore some chips built into mobile telephones only support the connection to a single station, which again makes a triangulation more difficult. As a result, an unnecessary time loss occurs during the establishment and ending of connections and further susceptibility during the navigation itself.

The known WLAN networks nowadays operate mainly at a frequency from 2.4-2.4835 GHz and have been able to establish themselves as technology for location determination within buildings. Present-day WLAN implementations already enable a precise determination of the signal strength since a transmitting station typically transmits a so-called beacon ten times per second at the lowest transmitting power. It is thus ensured that on receipt of a beacon, a stable connection can also be created which would then be maintained at correspondingly high transmitting power. On the basis of this beacon, otherwise however, without connecting to the respective network, the signal strength can be measured.

This is recorded at the receiver as an RSS (received signal strength) and, in the normal case declines the further removed the receiver is from the transmitter. The position determination within WLAN networks can take place by means of a plurality of different types of implementation. This includes (tri)lateration and so-called fingerprinting. Nowadays, a combination of the two possibilities is often found. In lateration, the distance from the access point (transmitter) and the client (receiver) is calculated. The location of the individual access points must be known for this and at least three access points must be acquired, so that on the basis of the calculated distance radii, an intersection point can be found that unambiguously marks the current dwell position. This method is very susceptible to the so-called multi-path problem and also to other signal interference. Particularly if only the minimum number of access points is available, large inaccuracies rapidly arise.

So-called fingerprinting is carried out between two phases. In the so-called offline phase, a grid is created with points in the area in which the navigation is later desired to be used. At each of these points, signal values of the surrounding WLAN networks are measured and stored—thus the RSS of the different networks in the range, and the unambiguous identification of the networks themselves is stored. This identification is designated the Basic Service Set Identifier (BSSID) and is defined in the IEEE standard as the MAC (Medium Access Control) address of a station.

This combination of different BSSIDs and their signal strength is typically unique, like a fingerprint. If sufficient comparison values have been collected, then the position determination can take place in the online phase. For this purpose, current measured values are sent to a server (e.g. building management system, cloud) provided the data have been externally saved or processed within the mobile device (mobile object) itself. By means of an algorithm which differs from method to method, most or the best matches of the values from the two phases are found and the associated point in the grid is determined. The fingerprinting is a very effort-intensive process due to the long preparation time in the offline phase, nevertheless, it forms the basis for the exact location determination with stable radio conditions, since with very many existing comparison data, short-lived measurement errors or inaccuracies can easily be balanced out.

WLAN has become established as a technology for indoor navigation. Not only inside but also outside of buildings, highly varied techniques have been used in order to achieve a precise position determination. A WLAN system is also relatively inexpensive. However, the interference susceptibility of the WLAN range/apparatus remains. The greatest WLAN problem is moisture. WLAN operates at the resonance frequency of water, 2.4 GHz. Thus, the WLAN is subject to interference wherever moisture is present in the masonry (or plaster board or wooden walls) or, for example, an underfloor heating system is installed. Steel-reinforced concrete floors and columns dampen the propagation of WLAN signals through a plurality of floors. The presence of large plants in the space can also somewhat impair the WLAN transmitting power; this is due to the high water content of plants. The presence of humans is therefore also a problem since these dynamically change the WLAN signals and thus the accuracy varies.

By means of the rapid further development of mobile IT in recent years, modern smartphones or other mobile communication devices have numerous sensors which can also be used for position determination of the user. This includes low-cost sensors, for example, accelerometers, magnetometers, gyroscopes, barometers. On the basis of this sensor data, the route followed by a user can be determined. In order to derive a navigation or the current location therefrom, however, the start point would first need to be known.

Some embodiments use so-called reference beacons for calibration and thus precisely determine the starting or transitory position. For this purpose, the beacon electronics is built into a housing which by means of its material properties (emission protection/screening) and/or use of antenna characteristics (“directional antenna”) radiates as far as possible in a bundled manner. In the case of mounting on the room ceiling, a radio beam oriented vertically downwardly should be emitted from the transmitting device to the smartphone. On installation in a wall or in a floor module, the beam should accordingly be emitted at the correct angle (e.g., at right-angles) to the receiver (smartphone, smart watch, smart glasses, etc.). By this means, the multipath problem is greatly reduced. Depending on the space characteristics and use, this bundled radio beam can also assume an emitting characteristic that is optimized therefor, for example, a 10°, 20°, 30° radiating angle. This can be realized as described by designing the housing, the antenna or the software setting. A bundled radio beam can be realized, for example, by means of a corresponding screening element (e.g. a cover).

In some embodiments, directional radio beams automatically adjust to the location of the user. The identification of the current location of a human or a device takes place with relatively coarse resolution by means of sensor technology and/or algorithms (e.g. sound, light or evaluation of radio wave reflection) in the reference beacon or separate hardware. This functions somewhat similarly to a movement detector. Thereupon, the reference beacon can communicate in a targeted manner, for example, by means of a dynamic antenna setting (e.g. mechanical change or software solution) by means of a radio beam, its reference beacon ID to the passing mobile object (smartphone, smart watch, smart glasses, tablet, etc.).

The target device receives the transmitted ID and the radiating direction of the antenna and can thus determine its position in the building and the room. This can take place offline in an app or online via a server connection. Thereafter, until the next (reference) beacon is reached, the navigation or position determination is carried out by means of the sensor installed in the device used by the user. On reaching the next reference beacon, the terminal device can recalibrate the deviation caused by the internal sensors.

Some embodiments may enormously reduce the investment in the building infrastructure, since only a few reference beacons must be used at “strategic throughways”. The positional accuracy herein remains sufficiently accurate. In principle, the position determination in high halls is thereby also possible if the reference beacons are installed at the hall entries, toilet entries, and other “narrow throughways”. The reference beacons may be positioned so that on passing, the position (or the building plan) can be exactly calibrated at the highest signal strength to less than one meter. This reference then serves, for example, as a starting point for further position determination via the sensors installed in the smartphone. The exact position data is optionally acquired in the building management system and provided to the user via WLAN or another transfer technology (e.g. 2G, 3G, 4G, etc. mobile radio; light or sound signal, etc.) e.g. by means of a server connection or e.g. per download on his mobile communication terminal.

In some embodiments, the reference beacon is installed for this purpose in an (at least) partially screened housing, so that as little reflected radiation as possible arises. The multipath problem is thereby reduced or prevented.

In some embodiments, the receiving of the position information by the holder of the mobile device takes place passively, simply by walking through the room. The holder or user need not himself be active and log in actively to a dedicated point in the room, e.g. by positioning the mobile device at a location in the building provided with an NFC beacon, barcode or QR code and receive the NFC beacon, barcode or QR code by means of the mobile device.

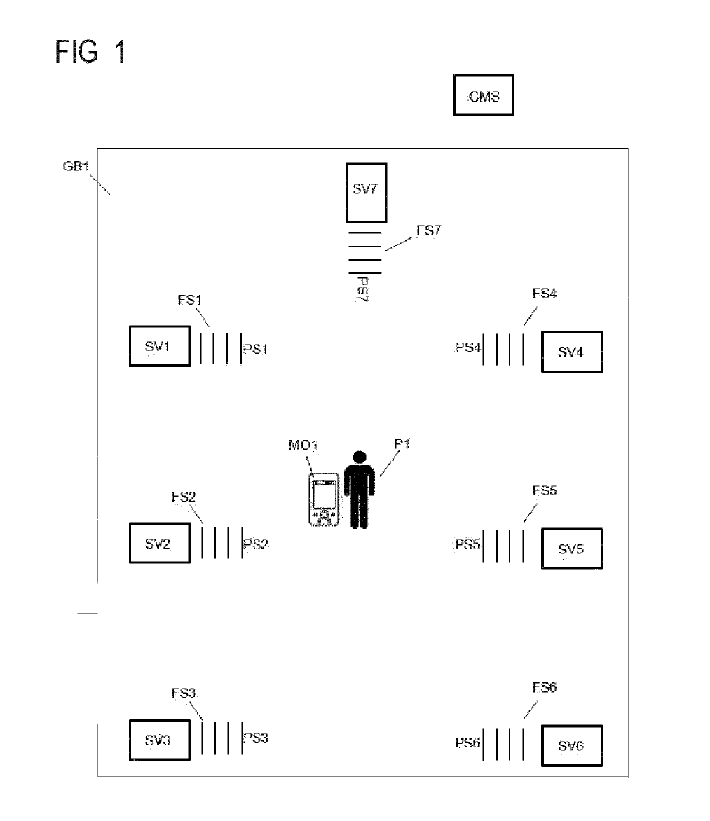

FIG. 1 is a first exemplary arrangement for calibrating the position of mobile objects MO1 in a building GB1. The arrangement comprises a transmitting device SV1-SV7 located in the building GB1 for transmitting an item of position information PS1-PS7 and/or a reference thereto, wherein the position information PS1-PS7 is unambiguously associated with the respective transmitting device SV1-SV7 (e.g. as the position in a building plan communicated from a building management system GMS to the mobile device MO1) and thus communicates the current location to the mobile object MO1 in the building GB1. The arrangement further comprises a mobile object MO1 (e.g. smartphone, smart watch, smart glasses, tablet computer).

The mobile object MO1 comprises a sensor (e.g. accelerometer, magnetometer, gyroscope, barometer) for position determination of the mobile object MO1 in the building GB1 and a receiving device (e.g. radio antenna for receiving radio signals) for receiving the position information and/or the reference thereto. The radio signal can herein contain the position information itself, e.g., the position information can be communicated directly to the mobile device (mobile object) MO1 or indirectly in the form of a reference (e.g. URL address) to the respective position information. The mobile object MO1 is configured, on the basis of the received position information PS1-PS7, to carry out a calibration of the position shown on the mobile object MO1 for position determination.

In some embodiments, the transmitting device SV1-SV7 is configured to transmit a bundled, in particular directional, radio beam FS1-FS7 with the position information PS1-PS7 and/or the reference thereto. Nowadays, a user or operator P usually has a mobile device MO1 (e.g. a smartphone) equipped as described above.

In some embodiments, the transmitting devices SV1-SV7 are positioned in the building GB1 at such sites at which visitors P in the building pass by in any event, e.g. at turnstiles, lifts, toilets, entries and exits.

In some embodiments, the building GB1 is operated with a building management system GMS. For example, building plans can be loaded by the building management system GMS onto the mobile device MO1. The mobile device MO1 can thus also be used for indoor navigation in the building.

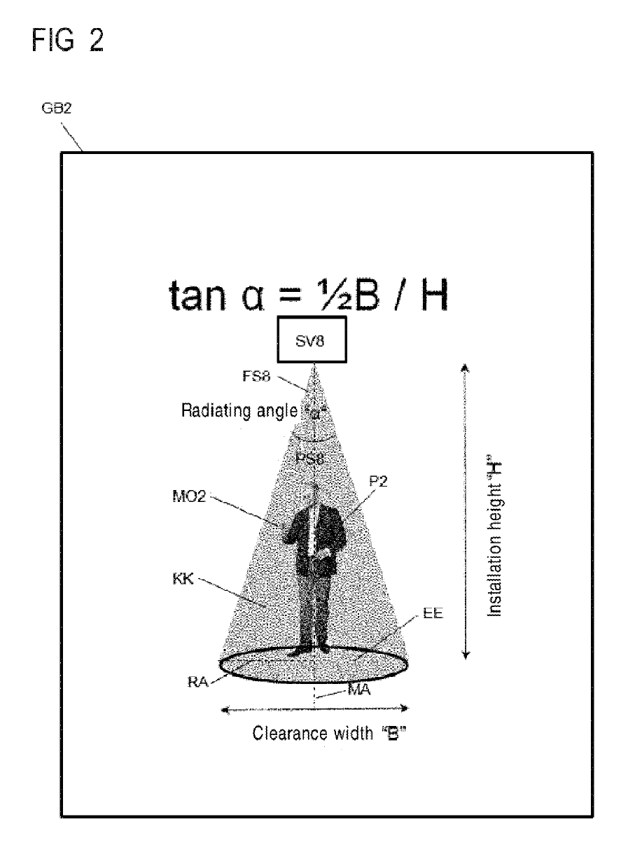

FIG. 2 is a second exemplary arrangement for calibrating the position of mobile objects MO2 in a building GB2. The second exemplary arrangement according to FIG. 2 comprises:
a transmitting device SV8 located in the building GB2 for transmitting an item of position information PS8 and/or a reference thereto, wherein the position information PS8 is unambiguously associated with the transmitting device SV8 and thus communicates the current location to the mobile object MO2 in the building GB2;
a mobile object MO2 (e.g. smartphone) with an integrated sensor technology for position determination of the mobile object MO2 in the building GB2 and a receiving device for receiving the position information PS8 and/or the reference thereto. The mobile object MO2 is configured, on the basis of the received position information PS8, to carry out a calibration of the position shown on the mobile object MO2 for position determination.

The transmitting device SV8 is configured to transmit a bundled, in particular directional, radio beam FS8 with the position information PS8 and/or the reference thereto. If the transmitting device SV8 is mounted on a room ceiling or corridor corner, the emission of the bundled, in particular directed, radio beam FS8 advantageously takes place substantially perpendicularly to the opposing floor as the receiving plane EE.

In some embodiments, the bundled (in particular directed) radio emitting region FS8 is radiated at an angle of not more than 10 degrees about its central axis from the transmitting device SV8. The central axis MA of the radio emitting region FS8 is thereby formed by the main radio beam. The radio emitting region FS8 is herein substantially rotationally symmetrically or conically shaped about the central axis MA.

In some embodiments, the bundled (in particular directed) radio emitting region FS8 is radiated in the form of a substantially straight circular cone KK by the transmitting device SV8, wherein the central axis MA of the circular cone is directed substantially perpendicularly to a receiving plane EE, wherein the aperture angle α forming the circular cone KK is not more than 19 degrees.

In some embodiments, the bundled (in particular directed) radio emitting region FS8 is radiated in the form of a substantially straight circular cone KK by the transmitting device SV8 in the direction of a receiving plane EE, wherein the central axis MA of the circular cone KK is directed substantially perpendicularly toward the receiving plane EE, wherein the aperture angle α forming the circular cone KK is selected so that the clearance width B formed by the circular cone on the receiving plane EE is not more than 1 meter.

In some embodiments, the position information and/or the reference thereto is receivable by the mobile object only in a radius of ±100 cm, in particular ±50 cm about the central axis MA of the radio beam FS8 on impacting upon the mobile object MO2. By this means, it is ensured that the position allocation takes place in a dedicated manner in the respective corresponding spatial region in the building.

In some embodiments, the radio beam is oriented vertically downwardly, so that any error is minimized (±50 cm); include in the description. In some embodiments, the angle α (radiating angle) for the radio emitting region FS8 is selected so that the mobile object MO2 (e.g. smartphone) crosses this emitting region FS8 in a radius RA of ±100 cm, in particular ±50 cm.

In some embodiments, the bundled radio beam FS8 is fed directed by the transmitting device SV8 to the mobile object MO2. Thus, the reliability of the communication of the position information PS8 is increased. The bundling of the radio beam FS8 serves to optimize the accuracy of the reference position PS8. The radiating angle α therefore depends on the structural environment conditions and can therefore vary. The variables are therefore the installation height H and the clearance width B.

In some embodiments, the radiating angle α is selected so that on application of the formula tan α=½ B/H lies in a region of not more than 1 m.

The arrangements according to FIG. 1 or FIG. 2 can also be used for calibrating the sensor technology of mobile objects in buildings, wherein a transmitting device situated in the building for transmitting an item of the position information and/or a reference thereto is present, wherein the position information is unambiguously associated with the transmitting device and thus communicates the current location to the mobile object in the building; wherein a mobile object is equipped with integrated sensor technology for position determination of the mobile object in a building with a receiving device for receiving the position information and/or the reference thereto; wherein the mobile object is configured, on the basis of the received position information, to undertake a calibration of the sensor technology integrated in the mobile object for position determination, wherein the transmitting device is configured to transmit a bundled, in particular directional, radio beam with the position information and/or the reference thereto.

In some embodiments, the mobile objects comprise portable electronic devices, for example, smartphones, smart watches, smart glasses or tablet computers which have a sensor technology, for example, accelerometer, magnetometer, gyroscope, barometer, acceleration sensors. This sensor technology can be used for position determination and/or navigation. This sensor technology has the disadvantage that its measuring results easily go “off course”. By means of the automatic calibration of the position, the measurement error is eliminated. This takes place without the interaction of the user of these mobile devices. A transmitting device with its respectively unambiguously associated position information acts like a reference beacon for the calibration or re-calibration. If the mobile object is situated in a radio emitting region of a transmitting device, the calibration or re-calibration of the mobile objects takes place on the basis of the position information respectively received in the respective radio emitting region by the mobile object. The transmitting device can be a WLAN, Bluetooth or Zigbee transmitter or a combination of transmitters (beacons).

In some embodiments, the transmitting device corresponds to a reference beacon which like a beacon light transmits its position information and this is then used for the calibration or re-calibration of the position of a mobile object (mobile device) and/or for the calibration or recalibration of the sensor technology of a mobile object.

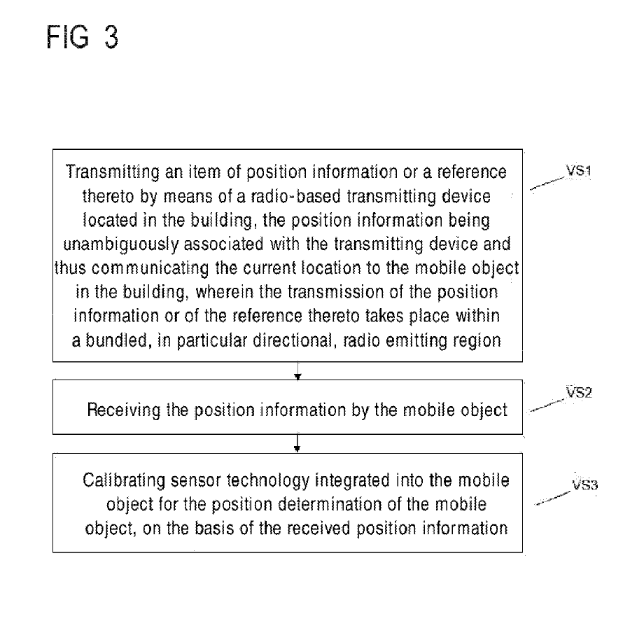

FIG. 3 shows an exemplary flow diagram for a method for the calibration of the position of mobile objects in buildings, the method comprising:
(VS1) transmitting an item of position information or a reference thereto by means of a radio-based transmitting device located in the building, wherein the position information is unambiguously associated with the transmitting device and thus communicates the current location to the mobile object in the building, wherein the transmission of the position information or of the reference thereto takes place within a bundled, in particular directional, radio emitting region;
(VS2) receiving the position information by means of the mobile object; and
(VS3) calibrating the position indicated at the mobile object for position determination of the mobile object, on the basis of the received position information. The method can be realized on the basis of infrastructure already provided in the building or on the basis of infrastructure (e.g. a smartphone) of a user (visitor).

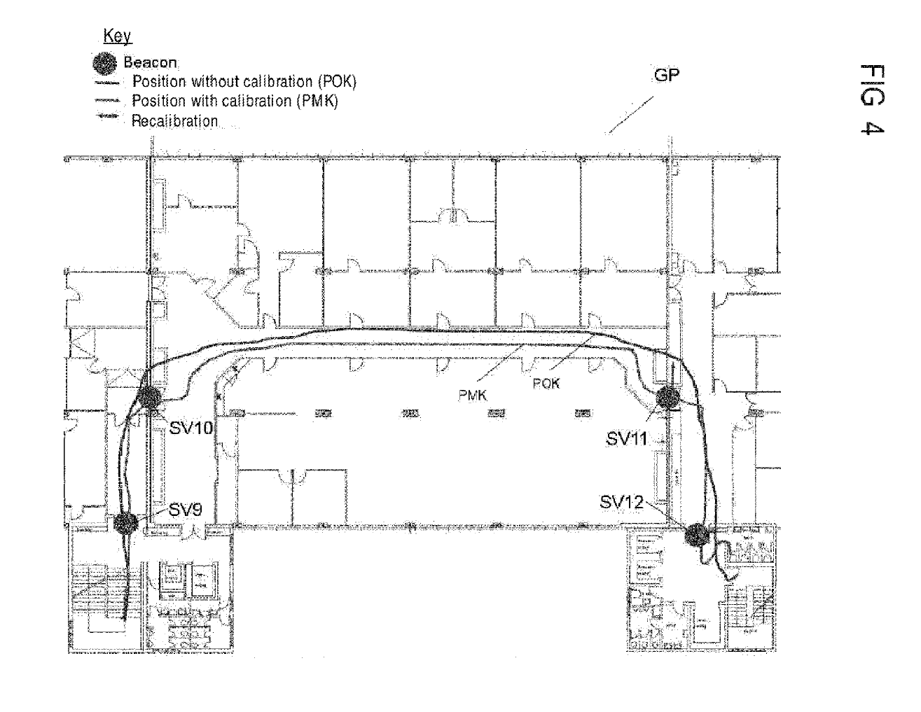

FIG. 4 shows an exemplary building plan GP with an exemplary position display. The building plan GP shows an exemplary layout for a floor of a building. In the representation according to FIG. 4, this is for the third floor in building 10 II (building 10 II, floor 3.0). The building plan GP can be represented on a mobile device (e.g. a smartphone, tablet, smart glasses) of a person situated in the building, in particular with the current position of the mobile device in the building. The current position can be represented on the plan GP, for example, by means of a flashing dot.

In particular for navigation in the building, the path already followed in the building can also be shown on the plan GP. In the representation according to FIG. 4, the red line on the plan GP shows the position or the route followed without calibration (POK) and the green line shows the position or the route with calibration (PMK). By way of example, transmitting devices SV9-SV12 (e.g. beacons) are represented on the building plan GP for recalibration of the position display on the plan GP. The beacons SV9-SV12 enable a calibration of the current position of the mobile object (e.g. smartphone, tablet, smart glasses) on the plans (GP) displayed on the mobile object, on the basis of the position information received by the mobile object, which the beacons SV9-SV12 emit.

In the representation according to FIG. 4, a recalibration at a position on the plan GP is shown by the respective black double arrows. A recalibration of the position of the mobile object on the plan GP can take place by means of a corresponding displacement of the respective position of the mobile object on the plan GP, according to the position information transmitted by the respective beacons SV9-SV12. The building plan GP can be loaded, for example, by means of a download (e.g. by means of a suitable app), to the mobile object. The building plan GP or the corresponding maps can be provided, for example, by a corresponding Internet provider or by a building management system.

### REFERENCE CHARACTERS

GB1, GB2 Buildings
SV1-SV12 Transmitting device
PS1-PS8 Position information
FS1-FS8 Radio beam
MO1, MO2 Mobile object
P1, P2 Person
GMS Building management system
α Radiating angle
H Installation height
B Clearance width
MA Central axis
RA Radius
KK Circular cone
EE Receiving plane
VS1-VS3 Method step
GP Building plan
POK Position without calibration
PMK Position with calibration

What is claimed is:

1. A method for determining a current position of mobile objects in buildings, said method comprising:
transmitting a referenced item of position information with a radio-based transmitting device located in the building to a mobile object, wherein the position information is unambiguously associated with the transmitting device and thus corresponds to a current location of the mobile object in the building;
transmitting a building plan to the mobile object for display thereon; and
providing a calibration calculation for determining
the current position of the mobile object on the plans displayed on the mobile object based at least in part on the received position information;
wherein transmission of the position information or of the reference thereto takes place within a directional radio emitting region.

2. A method for determining a current position of a mobile object in a building, said method comprising:
receiving an item of position information from a radio-based transmitting device located in the building, wherein the position information is unambiguously associated with the transmitting device and thus communicates the current location to the mobile object; and
calibrating sensor technology integrated into the mobile object for position determination of the mobile object based at least in part on the received position information;
wherein
transmission of the position information takes place within a directional radio emitting region.

3. The method as claimed in claim 1, wherein the bundled radio emitting region is radiated at an angle of not more than 10 degrees about its central axis from the transmitting device.

4. The method as claimed in claim 1, wherein:
the bundled radio emitting region is radiated in the form of a substantially straight circular cone by the transmitting device;
the central axis of the circular cone is directed substantially perpendicularly to a receiving plane; and
the aperture angle α forming the circular cone is not more than 19 degrees.

5. The method as claimed in claim 1, wherein:
the bundled radio emitting region is radiated in the form of a substantially straight circular cone by the transmitting device in the direction of a receiving plane;
the central axis of the circular cone is directed substantially perpendicularly toward the receiving plane; and
the aperture angle α forming the circular cone provides a clearance width formed by the circular cone on the receiving plane of not more than 1 meter.

6. The method as claimed in claim 1, wherein the cone is emitted downwardly in the vertical direction or in a horizontal direction.

7. The method as claimed in claim 1, wherein the position information is received by the mobile object in a radius of ±100 cm about the central axis of the radio beam on impacting upon the mobile object.

8. The method as claimed in claim 1, wherein the bundled radio beam is fed directed by the transmitting device to the mobile object.

9. The method as claimed in claim 2,
wherein:
using the received position information of the transmitting device, specifying a first location as a reference point of the mobile object in the building;
starting from the first location of the mobile object, using navigation sensor technology integrated into the mobile object, to continuously determine a current location of the mobile object;
receiving a second item of position information from a second transmitting device mounted at a second location associated with the further transmitting device; and
calibrating the currently determined location to the second location of the transmitting device when the second item of position information is received by the mobile object.

10. The method as claimed in claim 2, further comprising using the determined position of the mobile device to recalibrate digital maps or building plans of the building stored in the mobile object for position display.

11. An arrangement for mapping the position of mobile objects in buildings, said arrangement comprising
a transmitting device located in the building for transmitting an item of position information, wherein the position information is unambiguously associated with the transmitting device and thus communicates a current location to the mobile object in the building; and
a mobile object with integrated sensor technology for position determination of the mobile object in a building and a receiving device for receiving the position information;
wherein the mobile object includes a processor programmed to use the received position information to calibrate a position shown on the mobile object for position determination; and
the transmitting device transmits a directional radio beam with the position information.

12. An arrangement for mapping mobile objects in buildings, said arrangement comprising:
a transmitting device located in the building for transmitting an item of position information, wherein the position information is unambiguously associated with the transmitting device and thus communicates the current location to a mobile object in the building; and
a mobile object with integrated sensor technology for position determination of the mobile object in a building and a receiving device for receiving the position information;
wherein the mobile object includes a processor programmed to use the received position information to calibrate one or more sensors integrated into the mobile object for position determination;
the transmitting device transmits a directional radio beam with the position information.

13. The arrangement as claimed in claim 11, wherein the transmitting device transmits the bundled radio beam from the transmitting device at an angle of not more than 10 degrees about the central axis of the radio beam.

14. The arrangement as claimed in claim 11, wherein:
the bundled radio emitting region is radiated in the form of a substantially straight circular cone by the transmitting device in the direction of a receiving plane, the central axis of the circular cone is directed substantially perpendicularly toward the receiving plane; and
the aperture angle α forming the circular cone provides a clearance width formed by the circular cone on the receiving plane of not more than 1 meter.

15. The arrangement as claimed in claim 11, wherein the mobile object uses the received position information to reference digital maps or building plans stored in the mobile object for calibration of the position display on the mobile object.

16. The arrangement as claimed in claim 11, wherein the transmitting device feeds the bundled radio beam to the mobile object.

17. The arrangement as claimed in claim 11, wherein the transmitting device is mounted in the building at locations where, due to the construction of the building technical equipment in the building, persons situated in the building are detected with a high probability by the radio beam of the transmitting device.

18. The arrangement as claimed in claim 17, wherein the transmitting device is mounted at at least one of the following locations in the building: entries, exits, throughways, access to lifts, start and end of escalators, and/or access to toilets.

19. The arrangement as claimed in claim 11, wherein the transmitting device is integrated into an infrastructure element of the building.
